(19) United States
(12) Patent Application Publication
(10) Pub. No.: US 2010/0250723 A1
(43) Pub. Date: Sep. 30, 2010

(54) Contents distribution system, node device, leaving process delay method, and computer-readable recording medium in which leaving process delay control program is recorded

(75) Inventor: Masahiro Kamei, Nagoya-shi (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, NAGOYA-SHI (JP)

(21) Appl. No.: 12/659,302

(22) Filed: Mar. 3, 2010

(30) Foreign Application Priority Data
Mar. 26, 2009 (JP) 2009-075776

(51) Int. Cl. G06F 15/173; G06F 15/16

(52) U.S. Cl. 709/223; 709/230

(57) ABSTRACT

A node device in a contents distribution system receives instructions of leaving from a leaving node device which leaves the contents distribution system, and obtains transmission ability information concerning a transmission ability of the leaving node device. The node device determines a delay time in such a way that the higher the transmission ability is, the longer the delay time for use in delaying the leaving from the contents distribution system is, based on the obtained transmission ability information. The node device performs a leaving process from the contents distribution system after the determined delay time has elapsed after the receipt of the instructions of leaving

### CROSS REFERENCE TO RELATED APPLICATION

The present application claims priority from Japanese Patent Application No. 2009-75776, which was filed on Mar. 26, 2009, the disclosure of which is incorporated herein by reference in its entirety.

### BACKGROUND OF THE INVENTION

1. Field of the Invention

The present invention relates to a technical field of a communication system of a Peer-to-Peer (P2P) type which comprises a plurality of node devices which can communicate with each other through a network.

2. Discussion of Related Art

Concerning this kind of system, a related art discloses a distribution system in which a plurality of terminal devices are arranged in a tree type. A distribution system of a tree-type described in the related art is a distribution system of a peer-to-peer method. In a distribution system of a tree-type described in the related art, a broadcasting station (for example, a broadcasting device) is located at the highest level, and a plurality of node devices form a plurality of levels. A plurality of node devices which form such levels are connected through a communication means in a tree type. Contents distributed from a broadcasting station (for example, image data and audio data, and so on) are successively transmitted from a node device of a high level to a node device of a low level. The related art also discloses a technology in which a node device as a user terminal leaves a presently-participating hierarchy structure. Specifically, a technology is disclosed in which a leaving node device is set as a node device incapable of connection, and is caused not to be connected to another node device, until the transmission of contents stored in the leaving node device to a node device of a low level is terminated.

### SUMMARY OF THE INVENTION

In a technology described in the related art, however, in the case where a node device leaves a hierarchy structure mentioned above, a contents relay ability (transmission ability) of a node device is not taken into account. For example, if the leaving of a node device from a hierarchy structure is delayed, a node device unqualified for relay of contents remains connected to the hierarchy structure during such period of time. If there are a plurality of unqualified node devices, a connecting process of a newly-participating node device or a reconnecting node device is prevented. Therefore, since a node device with a low ability of relay remains in a contents distribution system, the distribution efficiency of contents distribution system is lowered. Further, in a contents distribution system of a peer-to-peer type other than a broadcasting system of a tree type, there is also a possibility that the similar problem occurs. For example, if there is a node device inadequate for distribution of contents, there is a possibility that a connection process is prevented, and the distribution efficiency is lowered, similarly with the above.

Thus, although the leaving of a node device is originally delayed in order to stabilize a contents distribution system, there is a problem of the system becoming unstable, contrary to the purpose.

Therefore, the present invention has been accomplished in light of the above point. It is an object of the present invention to provide a contents distribution system, a node device, a leaving process delay method, and a computer-readable recording medium in which a leaving process delay control program is recorded, capable of delaying the leaving of a node device from a contents distribution system, and resolving an unstable condition of the system caused by the delay.

In order to solve the above problem, according to the invention according to claim 1, there is provided a node device in a contents distribution system in which contents are transmitted and received among a plurality of node devices, the contents distribution system comprises a plurality of the node devices which can be communicated to each other through a network, the node device comprising:

a receiving device configured to receive instructions of leaving from a leaving node device which leaves the contents distribution system,

an obtaining device configured to obtain transmission ability information concerning a transmission ability of the leaving node device from the receiving device which has received the instructions of leaving,

a determining device configured to determine a delay time in such a way that the higher the transmission ability is, the longer the delay time for use in delaying the leaving from the contents distribution system is, based on the transmission ability information obtained by the obtaining device, and

a leaving device configured to perform a leaving process from the contents distribution system when the determined delay time has elapsed after the receipt of the instructions of leaving by the receiving device.

### BRIEF DESCRIPTION OF THE DRAWINGS

FIG. 1 is a view illustrating an example of connection mode of each node device in a broadcasting system S of a tree type according to an embodiment.

FIG. 2 is a view illustrating an example of a schematic arrangement of a broadcasting station 10 according to an embodiment.

FIG. 3 is a view illustrating an example of a schematic structure of a connection destination introduction server 20 according to an embodiment.

FIG. 4 is a view illustrating an example of a schematic structure of a node Nn according to an embodiment.

FIG. 5 is a flow chart illustrating an example of a process at the time of detection of leaving indication of a CPU 304 in a node Nn according to an embodiment.

FIG. 6 is a flow chart illustrating an example of a process in a determination process of leaving delay time of a CPU 304 in a node Nn according to an embodiment.

FIG. 7 is a view illustrating an example of contents set in a determination table of leaving delay time according to an embodiment.

FIG. 8 is a flow chart illustrating an example of a process after a start of stream-receiving of a CPU 304 in a node Nn according to an embodiment.

### DESCRIPTION OF THE PREFERRED EMBODIMENTS

Referring now to the drawings, the preferred embodiments of the invention will be described.

### [1. a Structure of a Broadcasting System of a Tree Type]

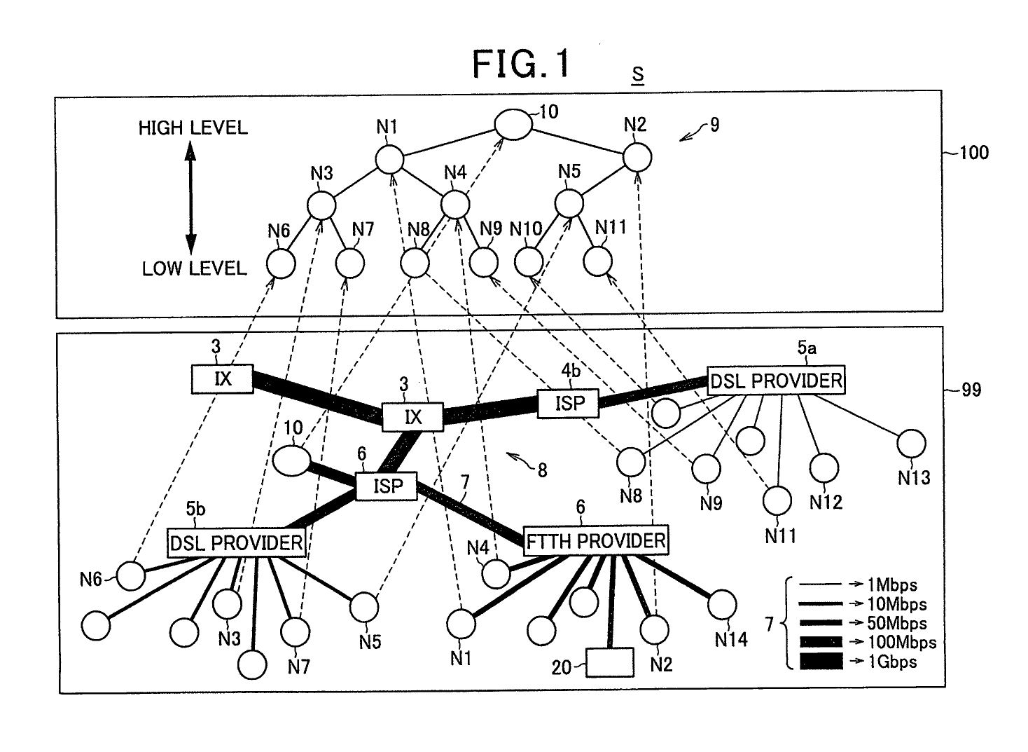

First, referring to FIG. 1, a schematic structure and a function of the whole of a broadcasting system of a tree type according to an embodiment of the invention will be described.

FIG. 1 is composed of a view 99 illustrating a detailed structure view 99 of a broadcasting system S of a tree type, and a view 100 illustrating a conceptual structure.

As shown in a detailed structure view 99 of a contents distribution storage system S, a network 8 such as an internet is structured by an IX (Internet eXchange) 3, ISPs (Internet Service Provider) 4a, 4b, devices 5a, 5b of a DSL (Digital Subscriber Line) provider, a device 6 of an FTTH (Fiber To The Home) provider, and a communication line 7, and so on. The network 8 is a communication network of a real world. A router for transmitting a data or a packet is inserted in the network 8 shown in an example of FIG. 1, as appropriate. In FIG. 1, however, an illustration thereof has been omitted. As the communication line 7, for example, a telephone line, a optical cable, and so on, is used.

A plurality of node devices Nn (n=any of 1, 2, 3, - - - ) are connected to such network 8. Hereinafter, a node device is referred to as “a node”. An inherent node ID is assigned to each node Nn.

A broadcasting system S of a tree-type according to the present embodiment is a network system of a peer-to-peer method. The broadcasting system of a tree type is formed (arranged) by participation of any nodes Nn among the nodes Nn, as shown in the view 100 illustrating a conceptual structure in FIG. 1. A network 9 shown in the view 100 illustrating a conceptual structure in FIG. 1 is a overlay network 9 which constitutes a virtual link formed by using the existing network 8. The overlay network 9 is a logical network.

In such broadcasting system S of a tree type, a plurality of nodes Nn participating in the system S form a plurality of levels with a broadcasting station 10 located at the highest, and are connected in a tree type through the network 8. Contents (a stream) broadcasted from the broadcasting station 10 are successively transmitted from a node Nn of a high level to a node Nn of a low level (ALM (Application Layer Multicast)). A data of a moving image is broadcasted, for example, by a streaming distribution method. The broadcasting station 10 is an example of a broadcasting device according to the present invention. Participation in a broadcasting system S of a tree type means that a node Nn connects with a topology of the broadcasting system S of a tree type.

This topology is arranged to be formed for each broadcasting channel. Each node Nn participates in a topology corresponding to a channel indicated by a user. A node Nn which has participated therein receives and transmits contents in the topology, and plays back the contents. For example, each node Nn plays back the received contents, and displays the played-back contents on a screen. Audio information of the received contents is outputted from a speaker. Thus, a user can view contents of channel which the user himself has selected.

A topology formed in a broadcasting system S of a tree type is managed by a connection destination introduction server 2. In accordance with a connection destination introduction request from a node Nn, the connection destination introduction server 2 introduces a node Nn as a connection destination, to a node Nn which has transmitted the connection destination introduction request. A node Nn as a connection destination is a node device as a connection destination in a broadcasting system S of a tree-type. A node Nn as a connection destination becomes to a node device which is located upstream from a node device which has transmitted the connection destination introduction request.

Further, in a system S of a tree type, a node Nn adequate for relay or transmission of contents is arranged to be preferentially connected as a node for relaying contents. A node Nn adequate for relay or transmission is, for example, a node device with a high ability of relay of contents. A detailed example of relay ability of contents will be described later. Hereinafter, a node Nn which relays contents is referred to as “a relay node”. A topology is formed in such a way that a node Nn inadequate for relay does not becomes to a relay node. That is, a node Nn with a low ability of relay is located in a low level of the topology. A node Nn inadequate for relay is a node Nn with a low ability of relay.

That is, a topology is formed in such a way that the higher an ability of relay of a node Nn is, the higher the node Nn is located in a level; the lower an ability of relay of a node Nn is, the lower the node Nn is located in a level. The forming of the topology is performed based on the management and control of the connection destination introduction server 20. Such method of forming a topology is known in Japanese Patent Laid-open No. 2003-169089, and so on. Therefore, a detailed explanation thereof will be omitted. In the case where a topology is formed by using a technology described in Japanese Patent Laid-open No. 2003-169089, as a connection destination of a node device newly participating in a topology, a node device which is located in a high level and which has a high ability of relay is introduced. Since the above-mentioned node device is introduced, the higher an ability of relay of a node Nn is, the higher the node Nn is located in a level; the lower an ability of relay of a node Nn is, the lower the node Nn is located in a level.

Furthermore, in a broadcasting system S of a tree type, when a node Nn leaves or withdraws from a topology, the following processes are performed. Specifically, after a predetermined time has elapsed after instructions of termination of viewing of contents by a user or after instructions of leaving a topology, a node Nn actually leaves. The instructions of termination of viewing of contents also mean instructions of leaving a topology. Hereinafter, the above-mentioned predetermined time is referred to as “a leaving delay time”.

Further, the leaving from a topology is also performed at the time of change of channel and at the time of termination of broadcasting, in addition to the case where there are instructions of termination of viewing. At the time of change of channel, when a user designates a channel of change destination, a node Nn leaves a topology in which it presently participates. The node Nn participates in a topology other than a topology which the node Nn has left. At the time of termination of broadcasting, the leaving from a topology is automatically performed.

Even in the case where instructions of leaving are issued, by causing a leaving process not to be performed at once, a change of topology can be restrained. That is, after the leaving has been instructed, before a leaving delay time elapses, there are some cases where re-participation in a topology is instructed by a user. In these cases, it is necessary to perform neither a leaving process nor a participation process. The re-participation in a topology includes re-viewing of contents, and return of channel by zapping. In this embodiment, as mentioned above, a topology is formed in such a way that a node Nn with a low ability of relay of contents is located at a low level. Therefore, if all nodes Nn delay the leaving for the same time evenly, there are some cases where a leaf node is occupied by a node Nn with a low ability of relay which is delaying the leaving, depending on timing. A leaf node is a node Nn to which another node Nn is not connected at its low level. Therefore, a leaf node is a node Nn which becomes to a candidate of connection destination of a node Nn which participates in a topology or a node Nn which makes a re-connection. Thus, it becomes to an obstruction of a connecting process by a node Nn which participates in a topology or a node Nn which makes a re-connection. Therefore, in a broadcasting system S of a tree-type, the higher an ability of relay of contents is, the longer a leaving delay time is; the lower an ability of relay of contents is, the shorter a leaving delay time is. Further, by such an arrangement, the higher an ability of relay of a node Nn is, the longer the node Nn can remain in a topology after the leaving has been instructed. During this time, since a relay process of contents by a node Nn with a high ability of relay can continue, the contents can be broadcasted stably. As a result, after instructions of leaving have been received, a node Nn with a relatively low ability of transmission or relay of contents leaves relatively early, and a node Nn with a relatively high ability of transmission or relay of contents remains in a contents distribution system for a relatively long time. Therefore, it can solve the situation where a system becomes to an unstable condition by delaying the leaving of a node device from a contents distribution system,

A method of re-structuring a topology after a node Nn has left a topology is known in Japanese Patent Laid-open No. 2006-33514, Japanese Patent Laid-open No. 2008-92004, and so on. Therefore, an detailed explanation thereof is omitted.

Now, a schematic operation from the time when a node Nn participates in a topology to the time when the node Nn leaves the topology will be described.

For example, assume that a node N13 shown in FIG. 1 participates in a certain topology by user's instructions. In this case, the node N13 transmits an upstream node introduction request message to a connection destination introduction server 20. The connection destination introduction server 20 retrieves a node Nn which can be connected to the downstream among topology management information managed therein. A node Nn which can be connected to the downstream is a node device for which the number of nodes directly connected to the downstream does not arrive at the allowable number of connections. The connection destination introduction server 20 returns an upstream node candidate introduction message to the node N13. The upstream node candidate introduction message includes information of network address of one or more upstream node candidates, and so on. By this process, the connection destination introduction server 20 introduces a connectable node Nn to the node N13. A node Nn which can be connected to the downstream is a node for which the number of nodes directly connected to the downstream does not arrive at the allowable number of connections. Then, the node N13 selects one node Nn among upstream node candidates obtained from the connection destination introduction server 20. For example, a node N6 shown in FIG. 1 is selected. The node N13 transmits a connection request message to the node N6.

Then, the node N6, based on the measuring result of an up-band-width of the node N6 itself, judges whether the node N6 is adequate for relay of contents. The measuring result of an up-band-width is stored in a predetermined storage means of the node N6. In the case where it has been judged that it is adequate for relay of contents, information of the node N13 is added to a node management table stored in the predetermined storage means of the node N6. The node N6 returns a connection permission response message to the node N13. The connection permission response message is a message of permitting another node Nn to be connected to a downstream position of a node Nn which has transmitted the connection permission response message. Then, the node N13 transmits a stream start request message to the node N6. The stream start request message is a message of instructing an upstream node Nn connected to the node Nn to start a stream. Finally, the node N6 prepares an object for relay of stream in a device, and starts streaming for the node N13. Thus, participation of the node N13 in a broadcasting system S of a tree type is accomplished.

Here, for example, assume that a node N6 is not adequate for relay of contents, in particular, assume that a relay ability of the node N6 does not arrive at a level of becoming to a relay node. In this case, a change of connection is performed, in the case where a relay ability of the node N13 is higher than that of the node N6, and so on. For example, the node N6 which has received a connection request message breaks a connection with, for example, a node N2 connected to an upstream of the node N6 (as a high level). Then, the node N6 transmits an upstream node connection instructions message including information of network address of the node N2, and so on, to the node N13. Then, the node N6 selects, for example, a node N12 among upstream node candidates introduced from the connection destination introduction server 20. The node N6 transmits a connection request message to the selected node N12. On the other hand, the node N13 which has received an upstream node connection instructions message transmits a connection request message to a node N2. Thus, the node N6 is connected to the node N12, and the node N13 is connected to the node N2, so that a change of connection is accomplished.

After that, in the case where the node N13 leaves a topology in accordance with instructions of leaving, a leaving delay time is determined based on a relay ability of the leaving node. After the delay time has elapsed, the node N13 performs a leaving process. In particular, the node N13 transmits a stream stop request message and a connection release request message to an upstream node N6 which supplies a stream. The stream stop request message is a message of causing a node Nn which has received the message to stop transmission of contents to a node Nn located downstream. The connection release request message is a message of releasing a connection between a node Nn which has received the message and a node Nn which is located downstream of a node Nn which has received the message. In response thereto, by discarding an object for relay of stream, the node N6 stops streaming for the node N13. At the same time, by deleting information of the node N13 from a node management table, the node N13 breaks a connection relationship with the node N6.

### [1-2. Structure of Broadcasting Station 10]

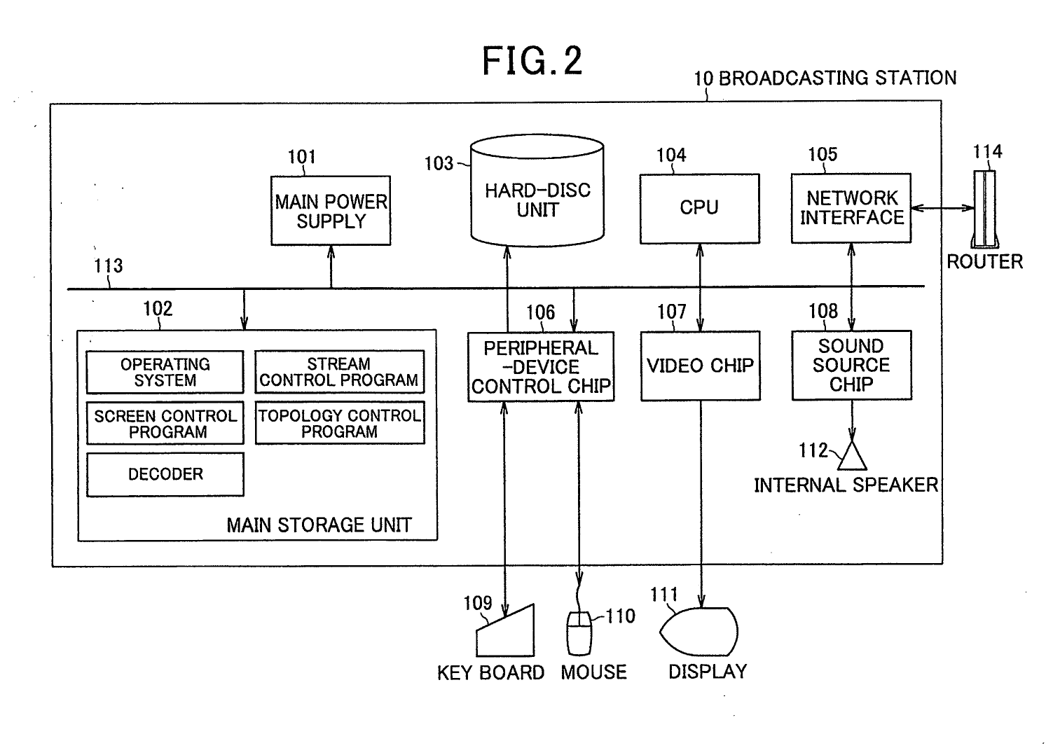

Referring now to FIG. 2, a structure and a function of a broadcasting station 10 will be described.

As shown in FIG. 2, the broadcasting station 10 is arranged to include a main power supply 101, a main storage unit 102, a hard-disc unit 103, a CPU 104, a network interface 105, a peripheral-device control chip 106, a video chip 107, a sound source chip 108, a keyboard 109, a mouse 110, a display 111, an internal speaker 112, and so on. The main power supply 101, the main storage unit 102, the hard-disc unit 103, the CPU 104, the network interface 105, the peripheral-device control chip 106, the video chip 107, and the sound source chip 108 are connected to each other through a system bus 113. The broadcasting station 10 is connected to a network 8 through a router 114.

The main storage unit 102 is arranged to include a RAM, a ROM, and so on. The main storage unit 102 stores an operating system, a stream control program, a screen control program, a topology control program, a decoder (program), and so on. The main storage unit 102 stores a node management table. In the node management table, node information concerning a node Nn connected to the broadcasting station 10 is registered. The node information is, for example, an IP address, a port number, and so on. The main storage unit 102 includes a buffer memory. The buffer memory is, for example, a ring buffer.

The hard-disc unit 103 stores contents for broadcasting.

The CPU 104 performs a broadcasting process of broadcasting or stream-distributing contents to a node Nn registered in a node management table in accordance with a variety of programs stored in the main storage unit 102. That is, the CPU 104, by performing a program, for example, packetizes contents recorded in the hard-disc unit 103, and transmits the resultant to a registered node Nn.

As such broadcasting station 10, in addition to an exclusive broadcasting server, any node Nn may be used.

### [1-3. Structure of Connection Destination Introduction Server 20]

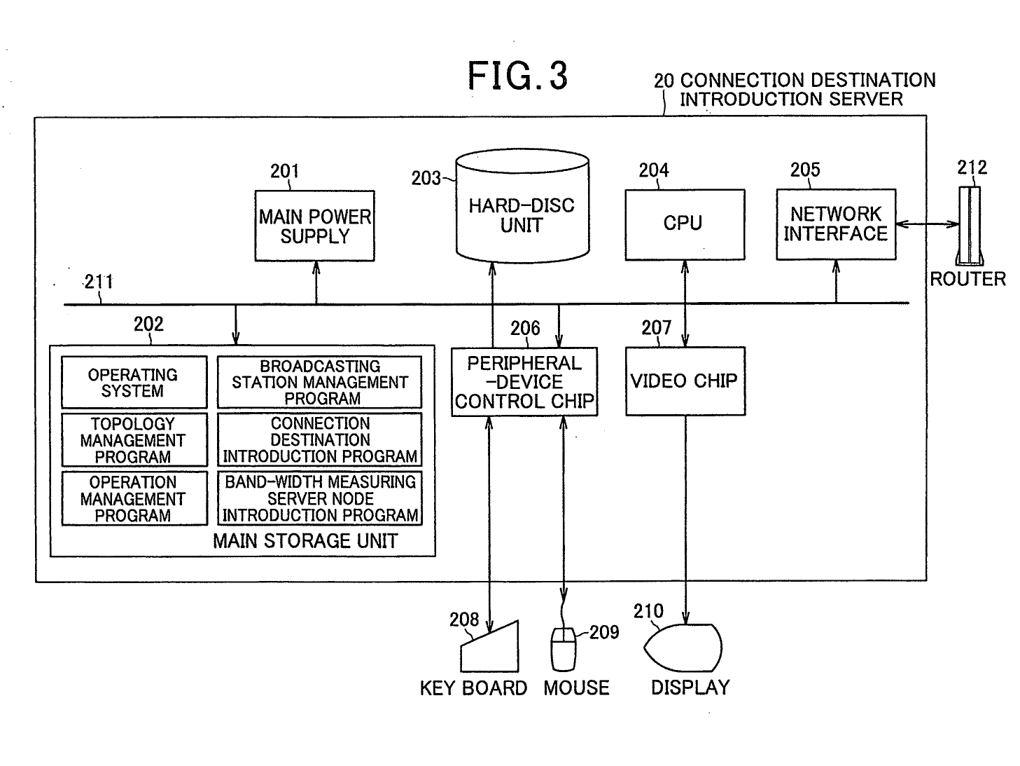

Referring now to FIG. 3, a structure and a function of a connection destination introduction server 20 will be described.

As shown in FIG. 3, the connection destination introduction server 20 is arranged to include a main power supply 201, a main storage unit 202, a hard-disc unit 203, a CPU 204, a network interface 205, a peripheral-device control chip 206, a video chip 207, a keyboard 208, a mouse 209, a display 210, and so on. The main power supply 201, the main storage unit 202, the hard-disc unit 203, the CPU 204, the network interface 205, the peripheral-device control chip 206, and the video chip 207 re connected to each other through a system bus 211. The connection destination introduction server 20 is connected to a network 8 through a router 212.

The main storage unit 202 is arranged to include a RAM, a ROM, and so on. The main storage unit 202 stores a server processing program, such as an operating system, a broadcasting-station management program, a topology management program, a connection destination introduction program, and an operation management program.

The hard-disc unit 203 stores a broadcasting-station management database, and a topology database. In the broadcasting-station management database, location information of each broadcasting station 10 is stored while corresponding to broadcasting channel information. The location information is, for example, a IP address, a port number, and so on. The broadcasting channel information is, for example, a channel number. In the topology database, topology management information is stored. The topology management information exists for each broadcasting channel. The topology management information is stored in the topology database while corresponding to the broadcasting channel information. The topology management information includes, for each node Nn participating in a topology, network address information, information indicative of a downstream node Nn being presently connected, information concerning the number of connections of downstream nodes Nn being presently connected, the permission number of connections of downstream nodes Nn, and so on, in a corresponding manner. The network address information is, for example, an IP address and a port number. The information indicative of a downstream node Nn being presently connected is, for example, a node ID. As the permission number of connections of a downstream node Nn, for example, a value of “2” may be set, or a value bigger than this value may be set.

The CPU 204 retrieves a node Nn connectable to the downstream from the above topology management information in accordance with a connection destination introduction request from a node Nn. For example, a node Nn which desires to newly participate in a topology transmits a connection destination introduction request to a connection destination introduction server 20. The CPU 204 performs an introduction process of introducing a candidate of one or more retrieved nodes Nn as a connection destination in accordance with a variety of programs stored in the main storage unit 202.

Here, a node Nn connectable to the downstream is limited to a node Nn for which the number of connections of a downstream node Nn being presently connected is smaller than the permission number of connections.

### [1-4. Structure of Node Nn]

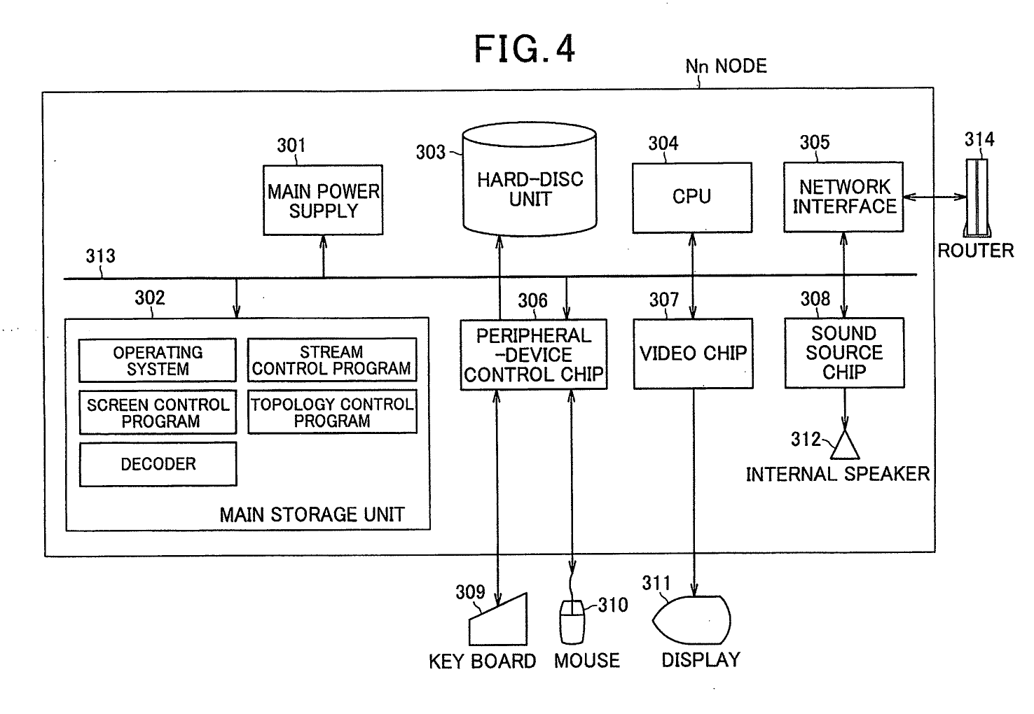

Referring now to FIG. 4, a structure an a function of a node Nn will be described.

As shown in FIG. 4, a node Nn is arranged to include a main power supply 301, a main storage unit 302, a hard-disc unit 303, a CPU 304, a network interface 305, a peripheral-device control chip 306, a video chip 307, a sound source chip 308, a keyboard 309, a mouse 310, a display 311, an internal speaker 312, and so on. An auxiliary power supply 301b, the main storage unit 302, the hard-disc unit 303, the CPU 304, the network interface 305, the peripheral-device control chip 306, the video chip 307, and the sound source chip 308 are connected to each other through a system bus 313. A node Nn is connected to a network 8 through a router 314. A computer according to the present embodiment is arranged to include the CPU 304 and the main storage unit 302.

As a node Nn, a PC, an STB (Set Top Box), a television set, or the like may be used.

The main storage unit 302 is arranged to include a RAM, a ROM, and so on. The main storage unit 302 stores an operating system, a screen control program, a stream control program, a topology control program, a decoder (program), and so on. A variety of these programs may be, for example, downloaded from a predetermined server in a network 8. Further, for example, they may be stored in a recording medium such as a CD-ROM, and read through a drive of the recording medium.

The main storage unit 302 includes a buffer memory for temporarily storing received contents. The buffer memory is, for example, a ring buffer. The main storage unit 302 stores a node management table. In the node management table, network address information of a downstream node Nn connected to a node Nn itself for storing the node management table is stored. The network address information is, for example, an IP address and a port number. As the permission number of connections of a downstream node Nn, for example, a value of “2” may be set, or a value bigger than this value may be set.

In the main storage unit 302, relay ability judgment information for judging a relay ability of a node itself which includes the main storage unit 302 is stored. That is, the relay ability judgment information is information used for calculating a leaving delay time. As the relay ability judgment information, a variety of information can be used.

In a first embodiment, as the relay ability judgment information, an up-band-width of a node Nn itself is used. In this case, the wider an up-band-width is, namely, the faster an up-line speed is, the higher a relay ability is. Measurement of an up-band-width is performed, for example, by that fact that a node Nn transmits data to a server for measuring an up-band-width. The server calculates efficiency of transmission, or speed of transmission, at the time when data is received. The server for measuring an up-band-width returns efficiency of transmission or speed of transmission to a node Nn. The node Nn stores the received efficiency of transmission or speed of transmission as relay ability judgment information. Here, a predetermined server device such as a connection destination introduction server 20 may be a server for measuring an up-band-width, and the connection destination introduction server 20 may introduce an adequate node Nn among nodes Nn already participating in a topology as a server for measuring an up-band-width. As relay ability judgment information, a down-band-width may be used instead of a up-band-width. As a transmission ability, or a relay ability, an up-band-width of a leaving node device is used. As a result, a transmission ability can be obtained in a system other than a broadcasting system of a tree type, while it is not affected by a connection condition of another node device or the like. Further, the wider an up-band-width of a node Nn is, the longer the node Nn remains in a contents distribution system. Therefore, a large amount of contents corresponding thereto can be transmitted.

In a second example, as relay ability judgment information, a distance to a level where a node Nn itself is located from the lowest level in a topology in which it participates is used. A distance, to a level where a node Nn itself is located, from the lowest level in a topology in which the node Nn participates is, for example, the number of levels. In a broadcasting system S of a tree type, the lower a ability of relay of a node Nn is, the lower the node Nn is located in a level. Therefore, an approximate ability of relay of a node Nn can be judged with a distance from the lowest level. In this case, when the longer a distance from the lowest level is, the higher a relay ability is. The distance from the lowest level is obtained by the fact that a node Nn asks an introduction server 20. In the present embodiment, the lower an ability of transmission or relay of a node device is, the lower the node device is located in a level. As a result, transmission ability or a relay ability can be judged based on the number of levels from a level where a leaving node device is located to the lowest level. Since a node device with a small number of levels which is located in a low level, namely, a node device with a low ability of transmission or relay of contents leaves a system early, it is possible to overcome an unstable condition of system.

In a third example, as relay ability judgment information, a loss rate of packet at the time when contents are received is used. In this case, the lower a loss rate of packet is, namely, the higher the quality of receipt of contents is, the higher an ability of relay is. In this case, a node Nn which receives contents detects a loss of received packet. The node Nn which receives contents reports a loss of received packet as a sequence number of loss packet to an upstream node Nn periodically. A node Nn which has received the report calculates a loss rate of packet based on contents of the report. AS a result, since the result of transmission or transfer of contents by a node device is regarded as transmission ability or a relay ability, it is possible to determine a delay time based on a more practical transmission ability. The above-mentioned relay ability judgment information is not managed by each node Nn, but may be stored and managed by a predetermined server. Further, the above-mentioned relay ability judgment information may be stored and managed by a predetermined node Nn.

A CPU 304 functions as a receiving device, an obtaining device, a determining device, a leaving device, a connecting device, and the like, of the present invention, by reading and executing a variety of programs stored in a main storage unit 302. A variety of programs stored in the main storage unit 302 includes a program according to the present invention. In accordance with a variety of programs, the CPU 304 performs a participating process of participating in a topology relating to a broadcasting system S of a tree type or a certain broadcasting channel. A node Nn which has participated in a broadcasting system S of a tree-type, after the participation thereof, receives a packet of contents (a contents stream) broadcasted from a broadcasting station 10 or an upstream node Nn through a network interface 305. The node Nn performs a buffering process of a packet of the received contents, and performs a playback process thereof.

Here, in the above participating process, a node Nn transmits a connection destination introduction request to a connection destination introduction server 20. The node Nn is connected to an upstream node Nn introduced by the connection destination introduction server 20. That is, the node Nn establishes a session with the connection destination introduction server 20. By establishing a session, a stream start request is performed.

In the above playback process, a node Nn reads contents received and stored in a buffer memory. The node Nn decodes the read contents by a decoder. A moving-image data is, for example, a video data and an audio data. The node Nn outputs the decoded video data (video information) through a video chip 307 to a display 311. The node Nn outputs the decoded audio data (audio information) through a sound source chip 308 to an internal speaker 312, or an external speaker not shown.

In the case where another node Nn is connected at the position downstream of a node Nn itself, a CPU 304 performs a transmitting process of transmitting each packet of contents stored in a buffer memory to the downstream node Nn. That is, the node Nn performs a relay of contents stream.

Further, in the case where the CPU 304 has received a stream stop request message or a connection release request message from a downstream node Nn, the CPU 304 stops streaming to the downstream node Nn. A receiving node Nn which has received a stream stop request message or a connection release request message, by deleting information of a node Nn located downstream of the receiving node Nn from a node management table included in the receiving node Nn, releases the connection with the node Nn.

Furthermore, the CPU 304 as a detecting device detects instructions of leaving a topology. In particular, when the CPU 304 is instructed to terminate the viewing of contents by a user's operation of a keyboard 109 or a mouse 110, the CPU 304 detects instructions of termination of the viewing. When the CPU 304 is instructed to change a channel by a user's operation of a keyboard 109 or a mouse 110, the CPU 304 detects instructions of change of channel. The CPU 304 detects the termination of broadcasting of contents.

The CPU 304 as a transmission ability information obtaining device obtains relay ability judgment information. For example, in the case where the CPU 304 obtains an up-band-width of a node Nn itself as relay ability judgment information, a node Nn receives an up-band-width response message. The up-band-width response message is a message which, at the time when a node Nn participates in a topology, in accordance with the fact that a data has been transmitted to a band-width measuring server, is transmitted from the band-width measuring server. The up-band-width response message indicates an up-band-width. The CPU 304 causes an up-band-width indicated by the received up-hand-width response message as relay ability judgment information to be stored in a main storage unit 302. In the case where a distance from the lowest level is obtained as relay ability judgment information, the CPU 304 receives a distance response message. The distance response message is a message which, at the time when the CPU 304 determines a leaving delay time, has been transmitted from a connection destination introduction server 20 in accordance with the fact that the CPU 304 has transmitted a distance-asking message. The distance-asking message indicates the number of levels. The CPU 304 uses a distance indicated by the received distance response message as relay ability judgment information. In the case where a loss rate of packet is obtained as relay ability judgment information, the CPU 304 receives a packet loss report message. The packet loss report message is a message transmitted from a downstream node Nn connected to a node Nn itself. The packet loss report message indicates the number of packet loss, or a loss rate of packet. Based on the number of packet loss obtained from the packet loss report message, a loss rate of packet may be calculated. The CPU 304 regards the calculated loss rate of packet as relay ability judgment information, and updates relay ability judgment information stored in a main storage unit 302.

Further, at the time of leaving a topology, the CPU 304 as a delay time determining device determines a leaving delay time based on relay ability judgment information. In particular, assuming that a leaving delay time is T, the leaving delay time is calculated by the following equation:

T=α (alpha)+β (beta)

Here, α (alpha) is a basic delay time, and is a constant having a value equal to or more than 0. That is, no matter how low a relay ability is, the leaving is delayed for at least a (alpha) or more. On the other hand, β (beta) is a value which changes in accordance with a relay ability of a node Nn. The higher a relay ability indicated by relay ability judgment information is, the bigger a value is set. As a method of determining a leaving delay time, in addition to a method of using the above equation, for example, a table can be used. For example, an ability of relay is divided into a plurality of parts, and a table in which a leaving delay time is set for each divided part is stored in a main storage unit 302. In the table, the higher an ability of relay is in a divided part, the bigger (the longer) a value of a leaving delay time is set. The CPU 304 determines a leaving delay time, using such table.

Furthermore, after a leaving delay time has elapsed after the detection of instructions of termination of viewing, the CPU 304 as a delay device performs a process of leaving a topology. In particular, the CPU 304 transmits a stream stop request message and a connection release request message to an upstream node Nn to which a node Nn itself is connected. The node Nn disconnects the connection with the upstream node Nn. In the case where the node Nn itself is connected to a downstream node Nn, the CPU 304 transmits a connection release request message to the downstream node Nn. The node Nn disconnects the connection with the downstream node Nn. The CPU 304 transmits a leaving message to a connection destination introduction server 20. Thus, a leaving node Nn causes information concerning the leaving node Nn to be deleted from a topology managed by a connection destination introduction server 20.

### [2. Operation of a Broadcasting System S of a Tree Type]

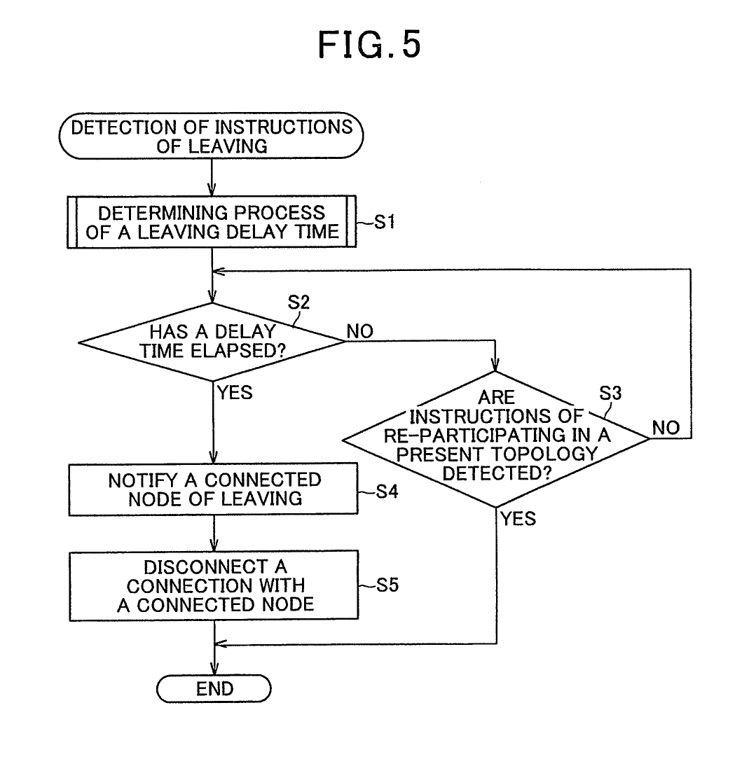

Referring now to FIG. 5 to FIG. 8, an operation of a broadcasting system S of a tree type according to the present embodiment will be described.

While a node Nn participates in a topology, when a CPU 304 detects the instructions of termination of viewing inputted by a user, the change of channel, or the termination of broadcasting, a process shown in FIG. 5 starts.

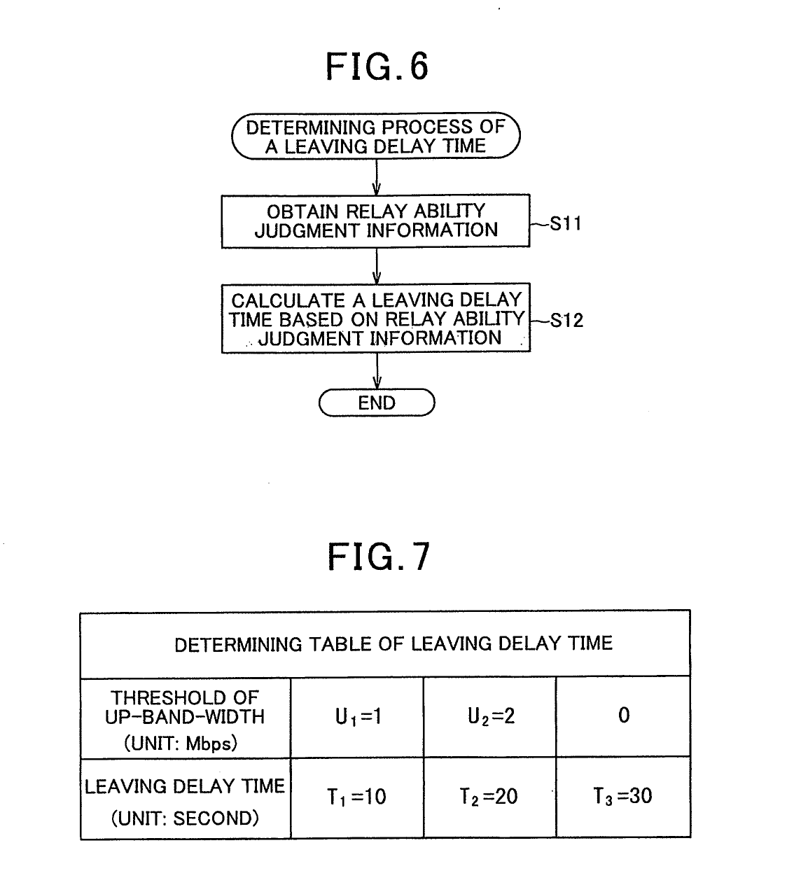

First, the CPU 304 starts a counting operation of a timer, and performs a leaving delay time determination process (step S1). In the leaving delay time determination process, the CPU 304 obtains relay ability judgment information, as shown in FIG. 6 (step S11). At this time, in the case where an up-band-width or a loss rate of packet of a node device itself is regarded as relay ability judgment information, the CPU 304 reads relay ability judgment information stored in a main storage unit 302. In the case where a distance from the lowest level is regarded as relay ability judgment information, the CPU 304 transmits a distance-asking message to a connection destination introduction server 20. By transmitting a distance-asking message, the CPU 304 receives a distance response message transmitted from the connection destination introduction server 20 as relay ability judgment information.

Then, The CPU 304, based on the obtained relay ability judgment information, determines a leaving delay time (step S12). For example, the CPU 304 calculates β (beta) by a predetermined function in which relay ability judgment information is regarded as a variable, and add a constant α (alpha) thereto to calculate a leaving delay time.

As another example of determining a leaving delay time, a case where a table is used will be described. A table of leaving delay time determination shown in FIG. 7 is an example of a case where an up-band-width is used as relay ability judgment information. In a table of leaving delay time determination in this case, a plurality of sets (each including a threshold of an up-band-width and a leaving delay time corresponding thereto) are set. For example, a leaving delay time T1=10 seconds is set for a threshold U1 of an up-band-width=1 Mbps. A leaving delay time T2=20 seconds is set for a threshold U2 of an up-band-width=2 Mbps. A leaving delay time T3=30 seconds is set for a threshold “0” of a up-band-width. A threshold of 0 is an invalid value. In the case where an up-band-width U obtained as relay ability judgment information is smaller than a threshold U1, the CPU 304 determines a leaving delay time T1=10. In the case where an up-band-width U is equal to or larger than a threshold U1 and smaller than a threshold U2, the CPU 304 determines a leaving delay time T2=20. In the case where an up-band-width U is equal to or larger than a threshold U2, the CPU 304 determines a leaving delay time T3=30. Thus, a leaving delay time is determined.

In the case where a loss rate of packet is used as relay ability judgment information, it is assumed that the larger a loss rate of packet is, the lower an ability of transmission is. It is also assumed that the smaller a loss rate of packet is, the higher an ability of transmission is. Therefore, in the case where a threshold of loss rate of packet is used instead of a threshold of an up-band-width in a table shown in FIG. 7, the lager a loss rate of packet is, the smaller a value of leaving delay time is set in a leaving delay time determination table. The smaller a loss rate of packet is, the larger a value of leaving delay time is set in a leaving delay time determination table.

When a leaving delay time is determined, the CPU 304 terminates a process of a leaving delay time determination.

Then, the CPU 304 judges whether a leaving delay time determined in a process of a leaving delay time determination has elapsed (step S2). In particular, the CPU 304 judges whether a value of a timer is equal to or higher than a value of a leaving delay time. The timer is not shown in the drawing, but is included in the CPU 304. At this time, in the case where a leaving delay time has not elapsed (step S2: NO), the CPU 304 judges whether instructions of re-participating in a topology presently being left are inputted by a user (step S3). At his time, in the case where instructions of re-participation is not inputted (step S3: NO), the CPU 304 moves to a step S2. On the other hand, in the case where instructions of re-participation has been inputted (step S3: YES), the CPU 304 stops leaving a topology (step S4, S5), stops a counting operation of a timer, and terminates the present process.

In the case where a leaving delay time has elapsed in step S2 (step S2: YES), the CPU 304 stops a counting operation of a timer, and notifies a node Nn connected to a node Nn itself, of the leaving (step S4). In particular, the CPU 304 transmits a stream stop request message and a connection release request message to an upstream node Nn.

Then, the CPU 304 disconnects a connection with a node connected to a node Nn itself (step S5), and terminates the present process.

In the above explanation, in the case where an up-band-width is used as relay ability judgment information, the CPU 304 reads information concerning an up-band-width stored in a main storage unit 302, and determines a leaving delay time. However, it is not limited to this method. For example, when an up-band-width is measured, a server device for measuring an up-band-width may determines a leaving delay time based on the measured up-band-width. In this case, a node Nn receives the determined leaving delay time from the server device for measuring an up-band-width. The node Nn causes the received leaving delay time to be stored in a main storage unit 302. The node Nn, at the time of leaving a topology, delays the leaving, using a leaving delay time stored in the main storage unit 302.

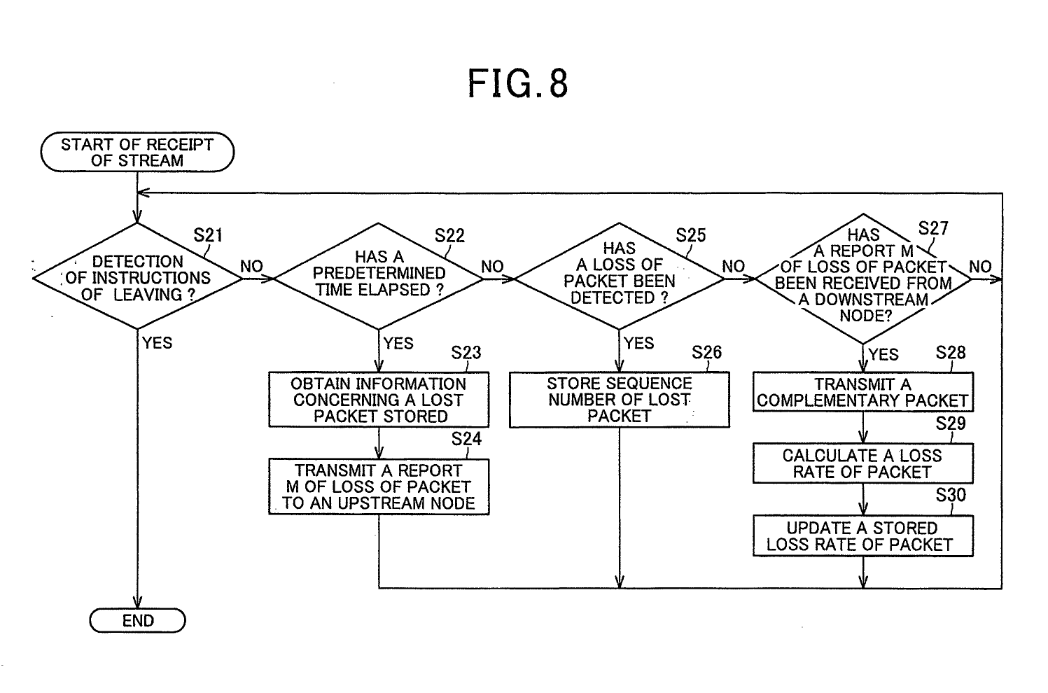

In the case where a loss rate of packet is used as relay ability judgment information, when a node Nn starts to receive a stream from a node Nn connected to the upstream, a process shown in FIG. 8 is started.

First, the CPU 304 judges whether instructions of leaving a topology have been detected (step S21). At this time, in the case where the instructions of leaving have not been detected (step S21: NO), the CPU 304 judges whether a predetermined time has elapsed (step S22).

At this time, in the case where a predetermined time has elapsed (step S22: YES), the CPU 304 obtains information concerning a lost packet stored in a main storage unit 302 (step S23). Then, the CPU reports a loss of packet to an upstream node Nn connected to a node device itself (step S24). In particular, the CPU 304 transmits a packet loss report message including recorded information concerning a lost packet, to an upstream node Nn. The CPU 304, after the termination of this process, moves to step S21. The information concerning a lost packet is a loss rate of packet, or the number of lost packets.

In the case where a predetermined time has not elapsed in step S22 (step S22: NO), the CPU 304 judges whether a packet loss by receipt of a stream has been detected (step S25). At this time, in the case where a packet loss has been detected (step S25: YES), the CPU 304 causes a sequence number of lost packet as information concerning a lost packet to be stored in a main storage unit 302 (step S26). The CPU 304, after the termination of this process, moves to step S21.

In the case where a packet loss has not been detected in step S25 (step S25: NO), the CPU 304 judges whether a report of packet loss has been received from a downstream node Nn connected to a node itself (step S27). This judgment is made by judging whether a packet loss report message has been received from a downstream node Nn. At this time, in the case where a packet loss report message has been received (step S27: YES), the CPU 304 transmits a complementary packet corresponding to a sequence number included in the packet loss report message, to a downstream node Nn (step S28). Then, the CPU 304, based on the number of sequence numbers included in the packet loss report message, calculates a loss rate of packet (step S29). Then, the CPU 304 updates a loss rate of packet as relay ability judgment information recorded in a main storage unit 302, to the calculated loss rate of packet (step S30). After the termination of this process, it moves to step S21.

In the case where a report of packet loss has not been received in step S27 (step S27: NO), the CPU 304 moves to step S21.

In step S21, in the case where instructions of leaving have been detected (step S21: YES), the CPU 304 terminates this process, and starts a process shown in FIG. 5.

As mentioned above, in accordance with the present embodiment, a CPU 304 of a node Nn detects instructions of leaving a topology. The CPU 304 of the node Nn obtains relay ability judgment information. The CPU 304 of the node Nn, based on the relay ability judgment information, determines a leaving delay time in such a way that the higher a relay ability of a node itself is, the longer the leaving delay time is. After the determined leaving delay time has elapsed after the detection of the instructions of leaving, the CPU 304 of the node Nn performs a leaving process.

Therefore, after instructions of leaving have been detected, a node Nn whose ability of transmission of contents is relatively low leaves relatively early. A node Nn whose ability of transmission of contents is relatively high remains in a broadcasting system S of a tree type for a relatively long time. Therefore, by delaying the leaving of a node Nn from a broadcasting system S of a tree type, it is possible to overcome an unstable condition of the system.

In the case where a CPU 304 of a node Nn obtains a loss rate of packet as relay ability judgment information at the time of receiving contents by a downstream node Nn which receives the contents from the node Nn itself, a leaving delay time is determined in such a way that the lower a loss rate of packet is, the longer the leaving delay time is.

Therefore, since the result of transmission of contents by a node Nn itself is regarded as an ability of relay, it is possible to determine a leaving delay time based on a more practical ability of relay.

In the case where a CPU 304 of a node Nn obtains an up-band-width of the node Nn itself as relay ability judgment information, a leaving delay time is determined in such a way that the wider the up-band-width is, the longer the leaving delay time is.

Therefore, the wider the up-band-width of a node Nn is, the longer the node Nn remains in a contents distribution system. So a large amount of contents corresponding thereto can be transmitted.

When a CPU 304 of a node Nn participates in a topology, the node Nn is connected to a node Nn in which the number of connections with its low-level nodes Nn does not exceed the permission number of connections among the already-participating nodes Nn as a node Nn of its low level. In the case where the CPU 304 of the node Nn obtains a distance (the number of levels) from the lowest level to a level in which the node Nn itself is located as relay ability judgment information from an introduction server 20, a leaving delay time is determined in such a way that the longer the distance is (the more the number of levels is), the longer the leaving delay time is.

Therefore, in a broadcasting system S of a tree type, the lower an ability of relay of a node Nn is, the lower the node Nn is located in a level. So an ability of relay can be judged from a distance from the lowest level to a level in which a node itself is located. Since a node Nn in which the distance is short and which is located in a low level, namely, a node Nn with a low ability of relay of contents leaves a system early, a connection process of a node Nn newly participating in a system or a node Nn making a re-connection is not prevented. Therefore, it is possible to transmit contents in a more stable fashion.

### [3. Example of Application of Contents Distributed Storage System]

Although the present invention has been applied to a broadcasting system of a tree type in the above embodiment, it can be applied to a network system of a peer-to-peer method other than the system, for example, a contents distributed storage system.

In a contents distributed storage system, a variety of contents which are different from each other are distributed, and stored in a plurality of nodes Nn. Hereinafter, a node Nn which stores contents is referred to as “a contents holding node”. In a contents distributed storage system of a network system of a peer-to-peer method, the contents are available among the respective nodes Nn.

When necessary contents are utilized, first, each node Nn retrieves a contents holding node which stores the contents. Hereinafter, a node Nn which utilizes contents is referred to as “a user node”. For example, in the case of a contents distributed storage system in which a Distributed Hash Table (DHT) is utilized, a user node transmits a contents location asking message of asking the location of contents, to any node Nn. By the routing in which the DHT is used, the message is finally transmitted to a node Nn which manages the location of contents. Hereinafter, a node Nn which manages the location of contents is referred to as “a root node”. A root node transmits a list of a node Nn which holds contents corresponding to a contents location asking message, to a user node. In the list of contents holding node, information concerning a location for use in accessing a contents holding node is recoded. The information concerning a location is, for example, an IP address and a port number of a contents holding node. A use node which has received a list of contents holding node requests contents from any node Nn among nodes Nn listed in the list. When a user node which has obtained the contents stores the contents, the user node issues a notification of registration (i.e., publishing). This message of notification of registration is also transmitted up to a root node. A root node which has received the message of notification of registration registers information concerning a location of a user node which has transmitted the message of notification of registration, as new information concerning a location of a contents holding node, in a list of contents holding node.

The detail of a contents distributed storage system in which a DHT is utilized is known, for example, in Japanese Patent Laid-open No. 2006-197400.

In the case of a contents distributed storage system of a so-called hybrid method, a location of contents is managed by a predetermined server device. In this case, each node Nn asks the server device about a location of contents directly.

In such contents distributed storage system, it is common that the more the number of nodes Nn presently participating is, the more a load of contents distribution is distributed. Therefore, when the leaving from a system is instructed by a user, it is also desirable to delay an actual process of leaving. This is because, while the leaving is delayed, the number of nodes Nn participating in a system is not reduced for a period of time corresponding thereto. However, a case where a node Nn with a very low ability of transmission of contents transmits contents is an exception. In this case, a receiving time of contents by a node Nn with a low ability of transmission becomes long, so that the efficiency of distribution of contents is lowered. On the other hand, if a node Nn with a high ability of transmission of contents remains, contents are transmitted by the node Nn with a high ability of transmission. That is, the possibility that a node Nn is selected as a contents holding node by a user is raised. Therefore, by transmitting contents by a node Nn with a high ability of transmission, the efficiency of distribution of contents is raised.

Therefore, in a contents distributed storage system, it is also arranged that the higher a transmission ability of contents is, the longer a leaving delay time from the time when the leaving from a system is instructed up to the time when a leaving process is actually performed is. Therefore, contents can be distributed effectively.

In a contents distributed storage system, for example, an up-band-width of a node itself, or a loss rate of packets can be used as information for use in judging a transmission ability of contents.

As mentioned above, the present invention can also applies to a contents distribution system of a peer-to-peer type other than a broadcasting system of a tree type.

The present invention is not confined to the configuration listed in the foregoing embodiments, but it is easily understood that the person skilled in the art can modify such configurations into various other modes, within the scope of the present invention described in the claims.

What is claimed is:

1. A node device in a contents distribution system in which contents are transmitted and received among a plurality of node devices, the contents distribution system comprises a plurality of the node devices which can be communicated to each other through a network, the node device comprising:
a receiving device configured to receive instructions of leaving from a leaving node device which leaves the contents distribution system,
an obtaining device configured to obtain transmission ability information concerning a transmission ability of the leaving node device from the receiving device which has received the instructions of leaving,
a determining device configured to determine a delay time in such a way that the higher the transmission ability is, the longer the delay time for use in delaying the leaving from the contents distribution system is, based on the transmission ability information obtained by the obtaining device, and
a leaving device configured to perform a leaving process from the contents distribution system when the determined delay time has elapsed after the receipt of the instructions of leaving by the receiving device.

2. A node device according to claim 1,
wherein the obtaining device obtains, as the transmission ability information, receipt quality information indicative of receipt quality when contents transmitted from the node device to the other node device are received by the other node device, and
the determining device determines the delay time in such a way that the higher the receipt quality indicated by the receipt quality information obtained by the obtaining device is, the longer the delay time is.

3. A node device according to claim 1,
wherein the obtaining device obtains band-width information indicative of an up-band-width of the node device as the transmission ability information, and
the determining device determines the delay time in such a way that the wider the up-band-width indicated by the obtained band-width information is, the longer the delay time is.

4. A node device according to claim 1,
wherein in the contents distribution system, a participation node device participating in the contents distribution system forms a plurality of levels with a broadcasting device located at the highest level,
in the contents distribution system, contents broadcasted from the broadcasting device are successively transmitted from a high node device of a high level to a low node device of a low level,
the participation node device is arranged in such a way that the higher a transmission ability of the participation node device is, the higher the participation node device is located in a level, based on the transmission ability information of the participation node device, and
wherein the obtaining device obtains level number information indicative of the number of levels from a level where the leaving node device is located up to the lowest level, as the transmission ability information, and
the determining device determines the delay time in such a way that the more the number of the levels indicated by the obtained level number information, the longer the delay time is.

5. A computer-readable recording medium in which a node processing program for making a computer function as a node device in a contents distribution system according to claim 1 is recorded.

6. A contents distribution system in which contents are transmitted and received among a plurality of node devices, the contents distribution system comprises a plurality of the node devices which can be communicated to each other through a network, comprising:
a receiving device configured to receive instructions of leaving from a leaving node device which leaves the contents distribution system,
an obtaining device configured to obtain transmission ability information concerning a transmission ability of the leaving node device from the receiving device which has received the instructions of leaving,
a determining device configured to determine a delay time in such a way that the higher the transmission ability is, the longer the delay time for use in delaying the leaving from the contents distribution system is, based on the transmission ability obtained by the obtaining device, and
a leaving device configured to perform a leaving process from the contents distribution system when the determined delay time has elapsed after the receipt of the instructions of leaving by the receiving device.

7. A method of leaving a node device in a contents distribution system in which contents are transmitted and received among a plurality of node devices, the contents distribution system comprises a plurality of the node devices which can be communicated to each other through a network, the method including steps, the steps comprising:
receiving instructions of leaving from a leaving node device which leaves the contents distribution system,
obtaining transmission ability information concerning a transmission ability of the leaving node device which has received the instructions of leaving in the receiving process,
determining a delay time in such a way that the higher the transmission ability is, the longer the delay time for use in delaying the leaving from the contents distribution system is, based on the transmission ability information obtained in the obtaining process, and
performing a leaving process from the contents distribution system when the determined delay time has elapsed after the receipt of the instructions of leaving in the receiving device.

8. A computer-readable recording medium recording a node processing program to be performed, in a contents distribution system in which contents are transmitted and received among a plurality of node devices, the contents distribution system comprises a plurality of the node devices which can be communicated to each other through a network, the node processing program comprising steps of:
receiving instructions of leaving from a leaving node device which leaves the contents distribution system,
obtaining transmission ability information concerning a transmission ability of the leaving node device which has received the instructions of leaving in the receiving process,
determining a delay time in such a way that the higher the transmission ability is, the longer the delay time for use in delaying the leaving from the contents distribution system is, based on the transmission ability information obtained in the obtaining process, and
performing a leaving process from the contents distribution system when the determined delay time has elapsed after the receipt of the instructions of leaving in the receiving device.
